(19) United States
(12) Patent Application Publication
(10) Pub. No.: US 2006/0087911 A1
(43) Pub. Date: Apr. 27, 2006

(54) Sample treatment station

(76) Inventors: Helmut Herz, OBERSCHLEIBHEIM (DE); Klaus Kaufmann, Oberschleibheim (DE)

Correspondence Address: Baker & Hostetler;Washington Square, Suite 1100, 1050 Connecticut Avenue N W, Washington, DC, 20036, US

(21) Appl. No.: 10/521,358

(22) PCT Filed: Jul. 15, 2003
(86) PCT No.: PCT/EP03/07653

§ 371 Date: Jul. 26, 2005

(30) Foreign Application Priority Data
Jul. 16, 2002 (DE) 102 32 202.3

(51) Int. Cl. B01F 11/00; B01F 13/02; B01F 15/06

(52) U.S. Cl. 366/101; 366/144; 366/139; 366/146; 366/209; 366/231

(57) ABSTRACT

A sample processing station is created by which the samples filled into the sample wells of a microtiter plate are not only thoroughly mixed by intense shaking at one place and with one device unit, but that can also be subjected to a vacuum treatment without hindering and/or without making it impossible to manipulate the microtiter plate and automatically fill or empty samples, and without the need for conveying the concerned microtiter plate through several different processing stations. To this end, an evacuating plate unit is removably arranged over the microtiter plate, which is set over a shaking table plate, said evacuating plate spanning over the microtiter plate and designed to be sealed off in such a manner that it permits the generation of a vacuum in all of the sample containers. The evacuating plate unit is controllably connectable to a vacuum source or to a directed airflow source via ports which originate from the base of the device.

The invention concerns a sample processing station, which is comprised of the following:

a device base plate;

a shaking table plate vertically supported against said device base plate and movable in a horizontal plane;

with a shaking drive arranged between and connected to the two said plates for the horizontal movement of the shaking table plate, said movement essentially and exclusively being one of translation, with the means by which to arrest the shaking table plate into a precise resting position;

with a microtiter plate holding fixture provided on the shaking table plate; and

with a removable microtiter plate inserted in the holding fixture, said microtiter plate exhibiting a multitude of sample wells, which can be filled with samples or whose samples can be emptied out by an automatically activated filling or removing device.

Sample processing stations of this type are known from the German utility model patent 200 18 633.7.

For a better understanding of the invention, let us preface it with the following general observations.

In pharmaceutical research, in chemical synthesis of active ingredients, in microbiology, in the cultivation of cells in nutrient solutions, in the analysis, for example, of blood or tissue samples or of such similar objects, there has been, for years, an ongoing trend of continuous reduction in the quantity of the samples and of parallel processing of an ever increasing number of different individual samples under conditions that are more or less identical within a narrow limit range. The handling of such great numbers of individual samples has been made possible by the application of pipetting robot stations, of positioning robots, of fully automated analytical systems and by the development of appertaining software. The external dimensions of the sample container units, or so-called microtiter or microwell plates, became standardized with the harmonization of sample processing methods. Depending on the application, the microtiter plates each respectively have 24 sample containers in the range of milliliters or 96 sample containers in the range of 100 microliters or 384 sample containers in the range of 10 microliters or even 1,536 sample containers in the range of microliters. In the case of microtiter plates, we are dealing, for the most part, with plastic articles that are for one time use, since it is only with great difficulty that they can be sterilized or thoroughly cleaned for the purpose of reuse.

One of the most important processing steps consists in a good thorough mixing of the samples in the individual containers, said step being rendered increasingly difficult as the volume of the sample becomes more minute.

Another very important processing step also consists in the heat treatment of the samples in the sample containers under respectively overall similar conditions so that, either based on the selection or on a specific sequence, the heating, cooling or maintaining of the samples at a specified temperature as well as the process of concentrating by letting a suspension liquid or a solvent evaporate off, must also occur under conditions that are largely similar in the individual sample containers.

To evaporate aqueous or other types of suspension liquids and aqueous or other types of solvents and to concentrate the content substances present in the suspension or the content substances dissolved in the suspension, basically two different methods have been used to date, namely boiling of the samples by feed of a thermal output and blowing of the samples with directed airflow or inert gas for accelerating the evaporation process.

Often times, content substances are present that will be destroyed by boiling under normal pressure (about 100° C. in aqueous suspensions or solvents) which is why a gentle concentration by blowing of the samples with directed air is preferred for accelerating the evaporation process.

There is yet another known method of letting the samples boil, namely in a vacuum chamber, in such a manner that, for example, the aqueous suspension or solvents are brought to a boil at a pressure of 20 mbar, at a temperature of about 20° C. However in this case, the problems of bubble formation and retardation of boiling arise, inevitably leading the samples to boil over the edges of the sample containers and to foaming of the samples. Attempts were made to counter the occurrence of this by processing the samples in a centrifuge since the rising bubbles are able to pop at the proper rates of acceleration or the number of rising bubbles in the sample are kept to a minimum based on the field of gravity.

However, it is demonstrated that the individual sample processing steps on samples filled in sample containers of microtiter plates, namely the steps of thorough mixing by shaking, by various thermal treatment steps, by concentrating and for example, also by separating of content substances by means of magnetic bead treatment and such similar, made it necessary, up until now, to set up a series of sample processing stations which had to be operated either by hand or by a multitude of robotic manipulators, and accordingly, required extensive usage of space and large cost expenditures.

The invention proposes to resolve the task of designing a sample processing station of the type initially described in such a manner that the samples filled in the sample wells of a microtiter plate shall not only be intensely and thoroughly mixed at one location and by the use of a one unit device, but that it shall also be possible to subject said samples to a vacuum treatment without hindering or rendering impossible the manipulation of the microtiter plates or the automatic filling of samples or the removal of samples, for example, by means of a robotic pipetting device, and furthermore, without the need of conveying the concerned microtiter plates through several different processing stations.

This task is resolved by the invention based on the characteristics of claim 1, wherein a removable evacuating plate unit is therefore arranged to span over the microtiter plate, said evacuating plate being designed as air-tight in such a manner that it permits the generation of a vacuum in all of the sample wells of the microtiter plate and said evacuating plate unit being controllably accessible via ports to a vacuum source or to a directed airflow source in the base plate of the device.

The underlying design concept of the one processing station of the type described here provides for building up the processing station from a stack of plate-like device units set up over the device base and/or over the shaking table plate, said plate-like device units are all provided with catch elements on their edges, working in unison with the manipulator of a single robot and depending on the selected mode of operation, are either stackable or separable from one another, whereby the individual plate-like device units are provided with seals for sealing off the edges from the neighboring plate-like device units and also with seals for sealing off the lead-through channel configurations as well and that these seals deploy their sealing efficacy foremost upon activation of a vacuum between the plate-like device units and for aerating the spaces under vacuum, said setup makes it possible to simply detach the previously sealed off plate-like device units from one another.

Advantageous designs and complementary forms of embodiment of the sample processing station of the type provided here are characterized in the patent claims subsequent to the present patent claim 1, the contents of which are hereby expressly made to constitute the body of the description without the need, at this point, of having to repeat said formulation thereof.

Although said claims, as just mentioned, are subsequent to claim 1, they indeed bear characteristics and characteristic combinations, whose significance is inventively independent of the characteristics in claim 1 and shall be more closely detailed in the following description.

In the following, the invention shall be described based on a few forms of embodiment while establishing references to the respective drawing, in which:

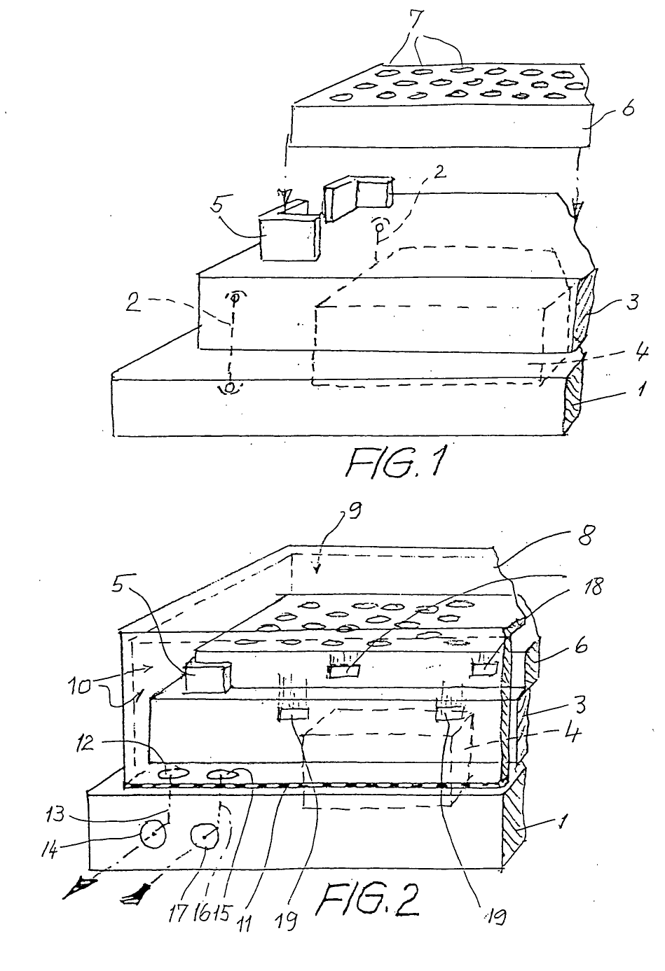

FIG. 1 is a schematic, perspective, sectional representation of a sample processing station of general type under consideration here, wherein the microtiter plate is represented as having been lifted from the shaking table plate;

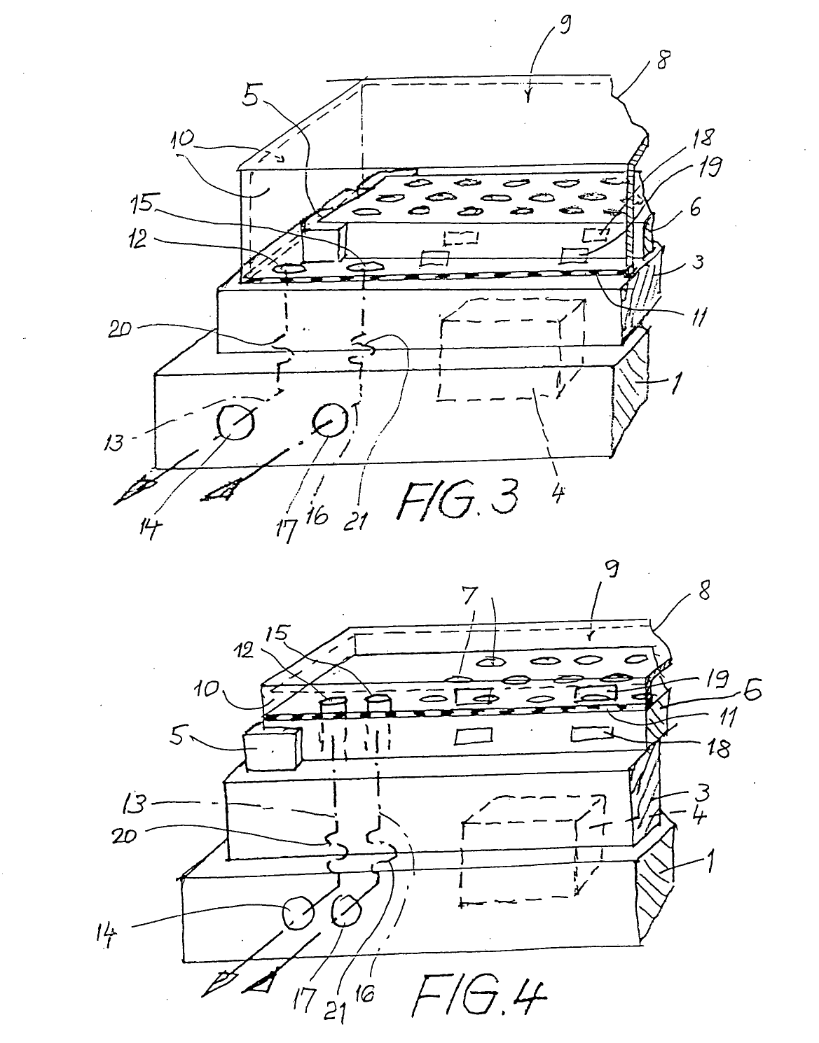

FIG. 2 is a perspective, schematic sectional representation of a first form of embodiment of the invention;

FIG. 3 reproduces a second form of embodiment of the sample processing station of the type provided here, with a representation similar to that in FIG. 2;

FIG. 4 shows a third form of embodiment of a sample processing station of the type provided here, with a form of representation similar to that in FIGS. 2 and 3;

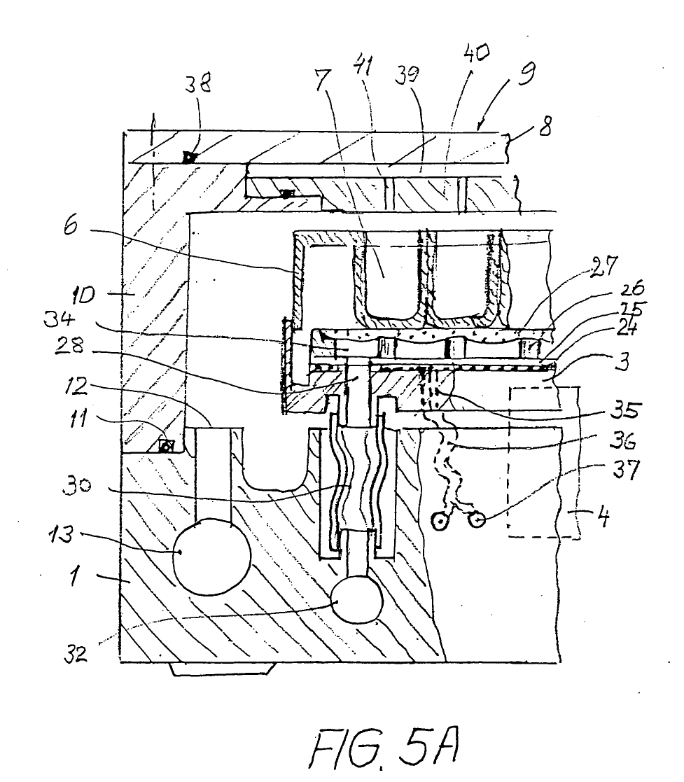

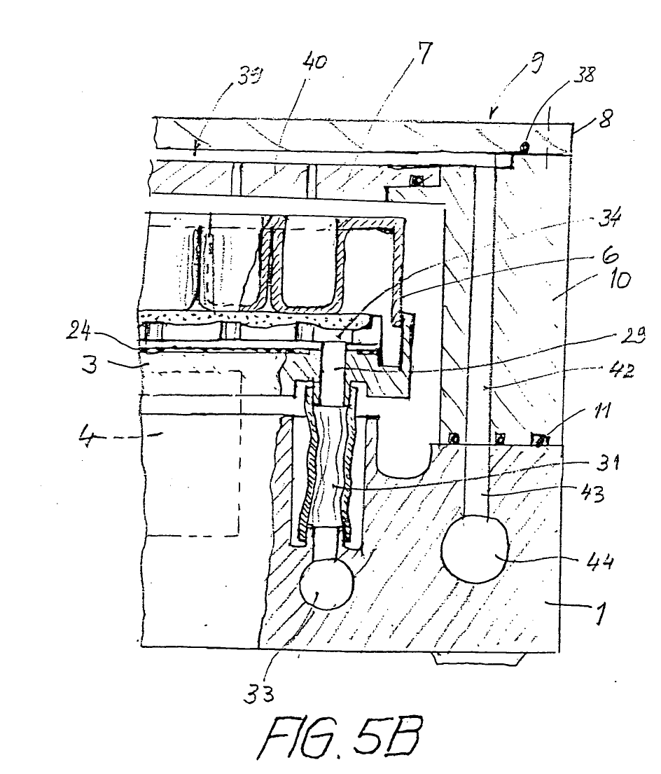

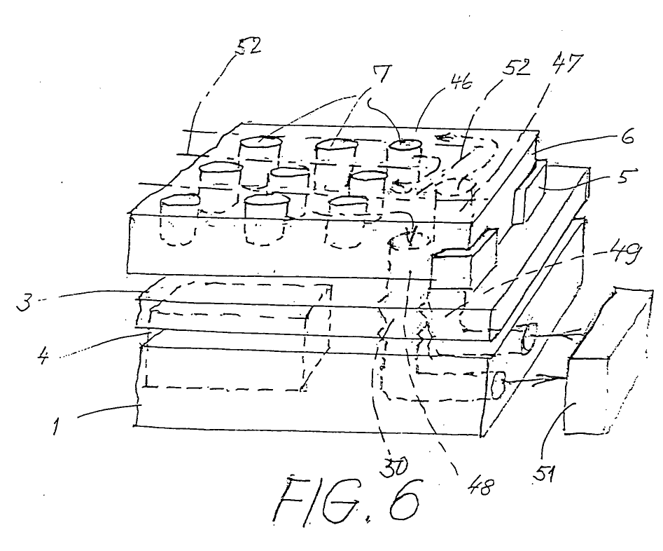

FIGS. 5A and 5B show schematic vertical sectional representations of the left portion or of the right portion of another form of embodiment of a sample processing station with the basic construction principle in accordance with FIG. 2;

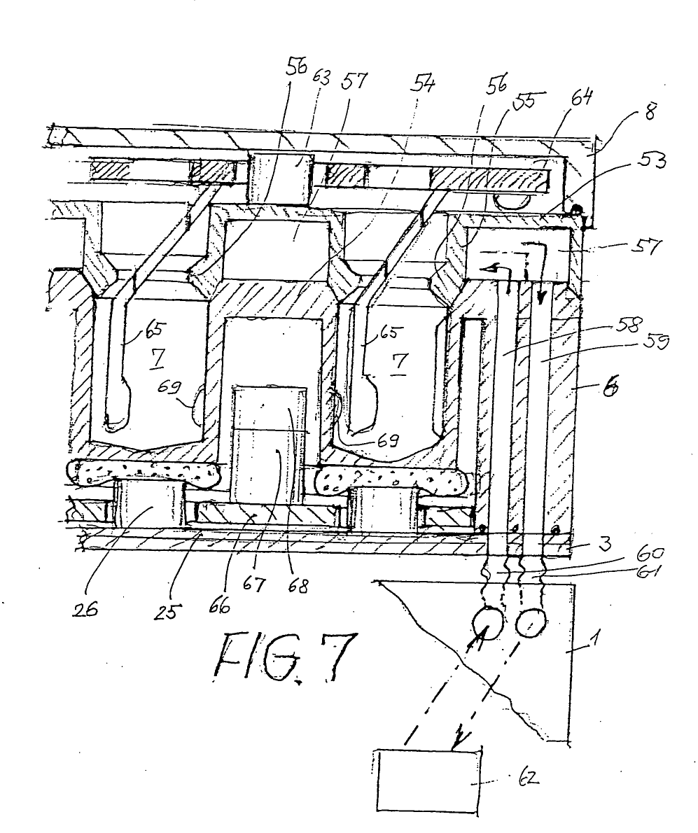

FIG. 6 reproduces a perspective, schematic, sectional representation of a detail of a sample processing station of the type provided here, whereby the detail can be provided as another form of embodiment of the sample processing stations in accordance with FIGS. 2 through 5B; and

FIG. 7 is a schematic sectional vertical section representation of a sample processing station of the type provided here with the basic design in accordance with FIG. 4, with a series of additional forms of embodiments and supplements for the implementation of additional processing steps.

FIG. 1 shows a sample processing station with a device base plate 1 over which is arranged a shaking table plate 3 that is movable in a horizontal plane and that is vertically supported against the device base plate 1, said shaking table plate being arranged by means of a swivel support construction, with a series of swivel supports projecting from the device base plate 1, of which one is schematically designated in FIG. 1 by reference number 2. Between the device base plate and the shaking table plate is located an electromagnetic shaking drive 4 for the horizontal movement of the shaking table plate 3, said movement exclusively and essentially being one of translation relative to the device plate 1. The shaking drive 4, for example, for the generation of circular translatory movements of the shaking plate 3 opposite the device base 1, can be designed, just as described in the previously mentioned German utility model patent 200 18 633.7 so that, at this point, a detailed description of the shaking drive 4 is rendered superfluous.

However, it is important, for example, by the special design of the swivel supports 2 or by spring loaded index pins, operating between the device base plate 1 and the shaking table plate 3, or even by means of a specifically controlled excitation of the electromagnetic shaking drive 4 during resting state, that it be ensured, that the shaking table plate is made to stop in a precise resting position opposite the device base plate as soon as the shaking movements of the shaking table plate cease. The significance of the means for arresting the shaking table plate at a precise resting position result from the necessity of having to automatically fill and empty a multitude of sample wells by means of a robotically activated pipetting device whose pipettes must precisely align with the positioning of the well openings.

On the shaking table plate 3 is located a microtiter plate holding fixture 5 in the form of retaining brackets arranged on the edge of the shaking table plate 3, said retaining brackets being arranged in proximity of the corners of the shaking table plate and defining, between themselves, a support surface over which a microtiter plate 6 can be positioned by insertion between the retaining brackets of the microtiter plate holding fixture. The microtiter plate holding fixture can be provided with cushioning means on the inward facing surface of the retaining brackets or with elastically yielding walls for these retaining brackets in order to be able to lower the microtiter plate 6 on to the shaking table plate 3 against a specific frictional resistance or repose angle and to be able to lift up said microtiter plate from the shaking table plate 3 against the mentioned resistance devices, for example, by means of the manipulator of a rotor.

The microtiter plate 6 exhibits a multitude of sample wells 7 whose inner spaces can be filled with samples or once again emptied after treatment by means of automatically activated filling or removing devices, for example, by a pipetting device with a multitude of filling or suctioning pipettes. The robotically activated and functionally computer controlled pipetting device is not represented in the drawing for reasons of gaining a clearer overview, but will be familiar to the expert skilled in this field.

The current invention relates to a sample processing station of the general type described in FIG. 1. It is noteworthy to mention here that the size scales and dimensions selected in the drawing do not seek to establish any claims on the full scale and also in particular, that the position and the cross section dimensions of the feed lines and evacuating lines for heat exchange media, vapors or gases in the drawing have been selected to be in certain positions for reasons of representation and moreover in terms of the view of the individual plate-like device units, but that in practice, the concerned plate-like device units can also be selected as being spaced further apart.

FIG. 2 shows a first form of embodiment of a sample processing station of the type claimed here with the basic construction in accordance with FIG. 1, in which are once again provided a device base plate 1, a shaking drive 4 connected to said base plate and to a shaking table plate 3 and a microtiter plate 6 that is removably set over the shaking table plate 3.

Located over the microtiter plate 6 and spanning over it is an evacuating plate unit 8 in the form of a hood, which exhibits a cover plate 9 as well as lateral walls 10 adjoining said cover while forming one unit whose lower edge against the base plate of the device, designed to make it gas-tight for the surroundings, is hermetically sealed off by means of a sealing strip 11 running around the circumference when the evacuating plate unit 8 is set over the shaking table plate 3 and the microtiter plate 6.

In the region of the edge of the upward extending surface between the shaking table plate 3 set back relative to the device base plate 1 and the inner walls of the evacuating plate unit 8 are located a flow port 12 of an evacuating channel 13 leading through the device base plate 1 by which the device base plate 1 can be connected to a vacuum pump by means of a schematically indicated hook-up 14 as well as a flow port 15 of a ventilating channel 16 leading through the device base plate 1 by which the device base plate 1 can be connected to a ventilating device by means of a hook-up 17. In the line section to the vacuum source or to the vacuum pump and to the directed airflow source, control means and measuring devices can be provided that are not shown in FIG. 2 for reasons of keeping the representation simple.

On the lateral edges of the microtiter plate 6, schematically indicated grasping elements are located to interact with a robotic manipulator, whereby said grasping elements, for example, in the form of rim recesses are designated by reference 18. In a corresponding manner, grasping elements 19 are provided on the side walls 10 of the evacuating plate unit 8.

When, for example, the microtiter plate 6 has been inserted between the retaining brackets 5 of the microtiter plate holding fixture by the robotic manipulator, which takes place when the evacuating plate unit 8 has been removed from the device base plate 1, then filling of the sample wells 7 of the microtiter plate 6 can subsequently take place by means of a pipetting device in the event this has not already been done prior to inserting the microtiter plate 6 in the microtiter plate holding fixture.

After this, the evacuating plate unit 8 is set over the shaking table plate 3 and the filled microtiter plate 6 so that the seal 11 running around the circumference of the lower edge of the side walls 10 lies against the upward extending surface of the device base plate 1.

Now when the connection is established between the inner space of the evacuating plate unit 8 and the vacuum source via the hook-up 14, the evacuating channel 13 and the flow port 12, then the evacuating plate unit 8 is firmly suctioned against the device base plate unit upon closure of the ventilating channel 16 and a vacuum is generated in the inner space of the evacuating plate unit 8 which acts upon all of the sample wells 7. This vacuum can be set in such a manner that even at an ambient temperature (for example of 20° C.) the contents of the sample wells 7 come to a boil in such a manner that the suspension carrier liquid or the solvent liquid in the samples within the sample wells 7 is evaporated and the samples are concentrated.

By simultaneously switching on the shaking drive 4, the samples can be made to circulate around the inner walls of the sample wells 7 and owing to this said samples are provided with a large surface relative to the evacuated surroundings within the evacuating plate unit 8. In addition to this and based on the centrifugal forces exerted upon the samples, the shaking motion has the effect of limiting the formation of bubbles or foam in the samples during boiling at a reduced pressure and thereby avoiding a retardation of boiling. This has already been mentioned.

The form of embodiment in accordance with FIG. 3 distinguishes itself from the one in accordance with FIG. 2 foremost in that the evacuating plate unit 8, which spans over the upper face of the microtiter plate 6, extends here with its downward side walls 10 to an upward facing, circumferentially running, peripheral region of the shaking table plate 3 located outside of the edge of the microtiter plate and which, in terms of the latter, is designed to be sealed off against flow media in the surroundings and can be hermetically sealed by a seal 11 running around the circumference. In the edge region of the upper face of the shaking table plate 3, between the lateral edges of the microtiter plate 6 and the inner wall of the lateral walls 10 of the evacuating plate unit 8 are located the flow port 12 of an evacuating channel 13 and the flow port 15 of a ventilating channel 16, whereby over the course of the evacuating channel 13 between the flow port 12 and the hook-up 14 on the device base plate 1 in the form of embodiment in accordance with FIG. 3, an elastically pliable channel segment 20 is provided, and over the course of the ventilating channel 16 between the flow port 15 and the hook-up 17 of the device base plate 1, an elastically pliable channel segment 21 is provided. The elastically pliable channel segments 20 and 21, which assume the form, for example, of flexible tubing segments, serve to establish the vacuum connection or the directed air connection while compensating for the horizontal shaking motions between the device base plate 1 and the shaking table plate 3 during operation of the shaking drive 4.

Incidentally, also provided in the form of embodiment in accordance with FIG. 3 are the robotic manipulator grasping elements 18 or 19 on the lateral edges of the microtiter plate 6 and on the side walls 10 of the evacuating plate unit 8 whose function was previously detailed in the context of the description of the form of embodiment in accordance with FIG. 2.

FIG. 4 shows a form of embodiment in which the evacuating plate unit 8 in a top view is essentially aligned with the microtiter plate 6 and against which the upward facing edge surrounding the openings of the sample wells 7 can be sealed off by means of a seal 11 along the lower edge of the side walls 10 as soon as the inner space of the evacuating plate unit 8 has been evacuated.

In an area of the microtiter plate 6 not taken up by the openings of the sample wells 7 are provided lead-through channel segments whose upper ends are once more formed by the flow ports designated by references 12 and 15 and which are aligned with the corresponding lead-through channel segments and which are sealed off by circumferential joints in the joint face, whereby the continuation of these lead-through channel segments runs downwards through the shaking table plate 3. These lead-through channel segments running through the shaking table plate 3 then transition into the flexible channel segments 20 or 21 of the evacuating channel 13 or of the ventilating channel 16 in order to compensate for the shaking motions between the device base plate 1 and the shaking table plate 3 in such a manner so that at last the flow port 12 is connected to the hook-up 14 for the vacuum source and the flow port 15 with the hook-up 17 for the ventilating source. Incidentally, the construction and mode of action of the form of embodiment in accordance with FIG. 4 correspond to the construction and to the mode of action of the previously described forms of embodiment, even in terms of the robotic manipulator grasping elements 18 and 19.

Let it be noted here that for reasons of gaining a good overview in the representation, the vertical dimensions, specifically of the evacuating plate unit 8 and also of the shaking table plate 3 are highly exaggerated in their representation. In any case, from a practical stance, value is placed thereupon that the center of gravity of the masses that are translatorily moved by the shaking drive 4 does not significantly rise above the shaking drive 4 so as to avoid tipping of the shaking table and of the plate-like construction components and masses arranged on top of them caused by forces of inertia.

Concerning the forms of embodiment in accordance with FIGS. 2 through 4 as well as the forms of embodiment yet to be described, it must be stated in general that of course there are indexing means provided between the stackable or separable plate-shaped device units, such as index pins and index boreholes, overlapping flange components and such similar elements, whereby such appertaining individual items have been largely omitted from the drawings for reasons of simplifying the representation.

In FIGS. 5A and 5B, in a vertical section that is partially schematic, is shown the right part or the left part of a form of embodiment of the basic construction in accordance with FIG. 2, whereby however, the sample processing station in accordance with FIGS. 5A and 5B makes it possible to have a series of additional functions and special processing steps based on specific further developments and special designs.

The form of embodiment in accordance with FIGS. 5A and 5B comprises once more a device base plate 1, a shaking table plate 3, a shaking drive 4 acting between the two latter plates 4 and retaining means on the shaking table plate 3 provided for detachable insertion of a microtiter plate 6. Swivel supports of the structural element type of reference 2 from FIG. 1 have also been omitted in the representation in accordance with FIGS. 5A and 5B just as in FIGS. 2 through 4, but they are nonetheless provided in areas outside of the cross sectional plane selected for representation. The function of said swivel supports is to lend support to the shaking table plate 3 in a vertical and horizontal plane of motion.

Formed in the device base plate 1 is an evacuation channel 13, which leads to a flow port 12 on the upper face of the device base plate 1. Set on top of the device base plate is a hood-shaped evacuation plate unit 8 which exhibits side walls 10 on whose lower end a seal 11 running circumferentially provides for vacuum tight sealing over the device base plate 1 as soon as the evacuating channel 13 is connected to a vacuum source and the evacuating plate unit 8 is suctioned against the device base plate 1. In the form of embodiment in accordance with FIGS. 5A and 5B, a ventilating channel can be provided with a ventilating opening corresponding to the flow port 12, but whereby the appertaining details are neither drawn into the present representation under consideration, nor are they absolutely required.

On the shaking table plate 3, which can bear a thermally insulating layer that is not drawn into the FIGS. 5A and 5B, is located a surface heating element 24, and on the latter is a heat distribution plate 25 from which heat transfer knobs project in the shape of cylindrical pins/studs 26 formed as one piece on the heat distribution plate. The heat transfer knobs 26 form a matrix configuration on the heat distribution plate 25 which corresponds to the matrix configuration of the sample wells 7 of the microtiter plate 6 in such a manner that respectively one upward extending surface of the heat distribution knob 26 faces opposite the base surface of one sample well 7.

Over the upper ends of the heat transfer knobs 26 is spread a heat transfer layer comprised of good heat conductive foamed plastic 27, which all around along its outer edges opposite a rim flange of the heat transfer plate 25, or facing away from here, opposite a rim flange which protrudes from the shaking table plate 3, is sealed off in such a manner that a sealed off space is formed between the upper face of the heat distribution plate 25 and the bottom face of the heat transfer layer 27, all around the heat transfer knobs 26.

From this space, a lead-through channel configuration 28 or 29, which penetrates the heat distribution plate 25, the surface heating element 24 and the shaking table plate 23, leads to a hose connection of the shaking table plate from whence a flexible hose segment 30 or 31 for balancing out the shaking motions between the device base plate 1 and the shaking table plate 3 leads to a hose connection of a channel system 32 or 33 formed in the device base plate 1. Over this channel system, the space located above the heat distribution plate 25 and beneath the heat transfer layer 27, around the heat transfer knobs 26, which is designated by reference 34, can be connected to an external cooling medium circuit for a functional purpose to be more closely detailed in the following. Packing means for sealing off the heat distribution plate 25 from the surface heating element 24 and from the shaking table plate 3 in the region of the lead-through channel configuration 28 or 29 are not drawn into the representation for reasons of simplification, however, the person skilled in the art would provide such packing means as well as amply dimensioned openings in the surface heating element 24 for the purpose of conducting the lead-through channel configuration 28 or 29 through there.

As can be seen from FIG. 5A, the surface heating element 24 is connected to a terminal 37 of the device base plate 1 for conducting electrical heating energy to the surface heating element 24, said connection being established by means of flexible electrical supply lines 36 set up through a line feedthrough 35 for the purpose of balancing out the relative motions between the device base plate 1 and the shaking table plate 3.

In contrast to the form of embodiment that is just schematically represented in FIG. 2, the evacuating plate unit 8 in the form of embodiment in accordance with FIGS. 5A and 5B has a cover 9 that is screwed down onto a frame formed by the side walls 10 and sealed off by a seal 38. Beneath the cover 9, within the boundary defined by the side walls 10 is located a gas dispensing chamber 39 that is flat, which is separated from the main chamber of the evacuating plate unit 8 lying directly over the microtiter plate 6 by a perforated plate 40 tightly pressed onto the rim flange of the side walls 10 of the evacuating plate unit 8.

Blast nozzles 41 of the perforated plate or a blast nozzle plate 40 form a matrix configuration, which corresponds to the sample wells 7 of the microtiter plate 6 relative to the vertical direction of the matrix configuration. The nozzle channels of the blast nozzles are therefore each respectively aligned with the corresponding sample well openings, whereby the drive amplitude of the shaking drive 4 is selected in such a manner that the flowing gas blasts discharged from the individual nozzle channels 41 and exhibiting unchanged positioning opposite the device base 1 always exclusively hit on the flow openings of the corresponding sample wells and do not swirl around on the rim regions around the sample well openings.

It can be seen from FIG. 5B that the flat chamber 39, which can also have the design of a blast medium supply channel system, which is formed inside of the cover 9 of the evacuating plate unit 8, which is indeed not represented, is connected to a controllable, in specific quanta blast gas chargeable admission channel 44 of the device base plate 1 via a lead-through channel segment 42 extending through the side wall 10 of the evacuating plate unit 8 and via another lead-through channel segment 43 in the device base plate 1.

In preparation of sample processing, the evacuating plate unit 8 is removed from the sample processing station and a microtiter plate 6 is set to fit over the shaking table plate 3, whereby the microtiter plate holding fixture and/or separate aligning means ensure that each bottom of a sample well 7 comes to lie over a heat transfer knob 26 of the heat distribution plate 25 and based on the yielding conformity of the interposed, good heat conducting heat transfer layer 27 composed of heat conducting foamed plastic, an intimate thermal bond comes about between the surface heating element 24 and the sample by way of the heat distribution plate 25, the heat transfer knobs 26 and the heat transfer layer 27 as well as finally by way of the base of each respective sample well.

After this, the evacuating plate unit 8 is placed on the device base plate 1 and the inner space is evacuated via the flow port 12 of the device base plate 1 as well as via the hook-up 13 by connecting the latter to a vacuum source. When the shaking drive 4 is switched on, then thorough mixing of the sample wells 7 follows and simultaneously, boiling takes place, for example, at an ambient temperature based on the vacuum inside of the evacuating plate unit for the purpose of concentrating the samples in a harmless and gentle manner.

In order to achieve short processing cycles during concentration, the admission of heating energy is required in addition to the evacuation, and for which thermal energy is supplied to the samples by switching on the surface heating element 24 connected to an electrical power source.

When a specified processing result has been achieved, for example, a specific concentration of the samples in the sample wells 7, which can be established by means of detectors that measure the rise in temperature, said detectors not being shown in the drawing, or which can be determined by way of the vapors extracted through the hook-up 13, then it is desirable, from this point forward, to very quickly terminate the heat supply to the samples. To this end, the electrical thermal energy supply to the surface heating element is switched off and a cooling medium circuit is made to take action via the connections 32 and 33, the flexible line connections 30 and 31, the lead-through channel configuration 28, 29 and the space 34 around the heat transfer knobs 26, said cooling medium circuit causing a very rapid drop in the temperature of the bases of the sample wells 7 and of the samples so that the boiling process can nearly instantaneously be brought to a standstill for all of the sample wells.

During the action of the vacuum on the samples in all of the sample wells 7 by evacuation of the inner space of the evacuating plate unit 8, flowing gas blasts via the nozzle channels 41 originating from the blast medium supply chamber 39 can be introduced into the individual sample wells 7, whereby the flowing gas blasts have the effect that even when the shaking drive 4 is in a state of repose, the surface of the sample, which is exposed to the vacuum, is enlarged and this promotes the evaporation process. In the case when the shaking drive 4 is in operation, the individual flowing gas blasts which enter into the inner chamber of the sample wells 7 also have the effect of mixing tools by dissolving surface elements which once again improves the dissipation of vapors. Since the flowing gas blasts are standing still relative to the device base plate 1 in the form of embodiment in accordance with FIGS. 5A and 5B while the microtiter plate 6 is engaged in a translatory circulatory movement when the shaking drive 4 is switched on, the flowing gas blasts not only effect the dissolution of surface elements for the improvement of the vaporization behavior but rather also succeed in keeping down and destroying otherwise rising gas bubbles and rising foam.

One recognizes the fact that the blast gas supplied through the admission channel or the port 44, such as for example, carbon dioxide or inert gas, need not necessarily be delivered under elevated pressure. Moreover, the gas supply via the admission channel 44 can also be delivered at ambient pressure or even with low pressure since the determining factor for the development of flowing gas blasts depends on the differential pressure between the blast medium supply chamber 39 and the inner space in the evacuating plate unit 8.

It has been shown that with the forms of embodiment of the sample processing station more or less according to the FIGS. 5A and 5B, that it is possible to concentrate the samples in a harmless and gentle manner with a relatively low admission of outside thermal energy while using flowing gas blasts directed at the samples in the sample wells within temporal cycles that amount to half the time required in conventional processing. It has hereby proven to be very advantageous when the regulation of temperature, heating and cooling or retrocooling can be controlled from sample well to sample well in the same manner within very narrow limits.

Instead of supplying the heating energy to the samples via the surface heating element 24, the heat distribution plate 25 and the heat transfer knobs 26 as well as via the heat transfer layer 27 or even also as a supplement to this heating system, temperature control, heating or cooling down of the samples in the sample wells can be conducted by means of a configuration schematically shown in FIG. 6. In the case of the design of the heating system for the sample processing station of the type provided here in accordance with FIG. 6, the microtiter plate 6 has a sample well connecting plate 46 that goes through at the level of the sample well flow openings, and at the level of the sample well bottom ends, either an impervious seal is provided by the coating on an elastically yielding mat or even a through-going sample well connecting plate can also be provided at this level, whereby the space around the individual sample wells 7 is imperviously sealed off in upward and downward direction as well as along the lateral edges of the microtiter plate 6. Via a lead-through channel configuration 47 or 48 outside of the region of the sample wells 7, exiting from below out of the microtiter plate 6 and extending through the shaking table plate, as well as via flexible line connections 49 and 50 in the direction of the device base plate 1, the enclosed space laterally around the sample well outer walls 7 can be controllably connected to a heating medium circuit or to a cooling medium circuit, whereby the external component of the heating medium circuit or of the cooling medium circuit is designated by reference number 51 in FIG. 6.

Schematically indicated by several dashed and dotted lines 52 in FIG. 6 are the flow directing walls which are integrated in the spaces between the sample wells 7 and the upper and lower sample well connecting plate so as to ensure a largely homogeneous current distribution along the external walls of the individual sample wells and to thereby achieve an essentially uniform heat distribution between the samples and the heat exchange media from one sample well to the next. If the heating system in accordance with FIG. 6 is additionally installed to the heating system described in accordance with FIGS. 5A and 5B in a sample processing station in accordance with FIGS. 5A and 5B, then it is demonstrated that individual temperature regulation, cooling and heating for different sample filling height levels in the sample wells 7 can be conducted in accordance with a previously determined program and based on desired selection.

FIG. 7 shows a practical application of a sample processing station of the type provided here in accordance with the basic construction as per FIG. 4, whereby here however, a channel opening plate 53 is arranged on the microtiter plate 4 that is rigidly secured to the latter, said channel plate being rigidly secured to the microtiter plate by being welded/sealed [if plastic]. At the level of the openings of the sample wells 7 of the microtiter plate 4 is located a sample well connecting plate 54 and from the channel opening plate 53, channel connections 55 project as one piece from each individual sample well opening. The channel connections 55 have the shape of tube flanges with lower slosh baffle rings 56 formed as one piece with a truncated pyramid-like ring cross section. The slosh baffle rings 56 inwardly oriented from the flow opening of the sample wells 7 have the effect of preventing the sample contents from being spattered out of their respective sample well during vigorous shaking motions by the shaking table plate 3 or by the microtiter plate 4, even in the case of a comparatively high sample fill level in the sample wells 7.

Between the upper sample well connecting plate of the microtiter plate 4 and the underside of the channel opening plate 53, a channel system 57 surrounding the flow channel connections and laterally sealed along the upper edges of the microtiter plate 4 is formed which can be controllably connected to the external component 62 of a cooling medium circuit in the direction of the device base plate 1, said connection being established via a lead-through channel configuration 58 or 59 extending through the microtiter plate 4 and through the shaking table plate 3 as well as via flexible line connections 60 or 61 to the device base plate 1. The withdrawal of heat in the region of the flow opening of the sample wells 7 has the effect, in the case of certain processing steps, of reducing sample loss caused by undesirable vaporization and can also be relied upon to contribute toward avoiding overheating the samples since the channel system or the chambers 57 can be impinged upon as quickly as desired by the cooling media independent of the other heat exchange devices. Let it be noted here, that the blast gas jets originating from these said channels 41 mentioned in this context in association with FIGS. 5A and 5B contribute to cooling off the samples, given the case that the blast gas is cooled, and they assist in preventing the overheating of the samples.

Over the upper edge of the channel opening plate 53 is set in an airtight manner the evacuating plate unit 8 whose inner space, not shown in FIG. 7, is connected to a vacuum port or a ventilation port of the device base plate 1 via a lead-through channel configuration penetrating the channel opening plate 53, the microtiter plate 4 and the shaking table plate 3 as well as via flexible line segments in an entirely corresponding manner as was described for the form of embodiment in accordance with FIG. 4.

According to a very advantageous feature of the form of embodiment in accordance with FIG. 7, the channel opening plate 53 is provided on its upper face with a series of support knobs 63 against which the cover 9 of the evacuating plate unit 8 can rest when the inner space of the evacuating plate unit 8 is being evacuated and the cover 9 has the tendency to deflect.

A corresponding configuration of support knobs can also be provided on the upper face of the sample well connecting plate of the microtiter plate 6 for the forms of embodiment in accordance with FIGS. 3 and 4. If such support knobs are provided on the upper face of the microtiter plate 6 in accordance with FIG. 3, then these support knobs have the additional advantage that while the cover 9 slightly dips downward under the effect of the vacuum, the microtiter plate 6 is made to press against the upper face of the shaking table plate 3 with additional staying power and thereby experiences an extra source of fixation during the shaking operation.

Certain samples or certain suspension carrier liquids or solvents have such a consistency or viscosity that thorough mixing can no longer be achieved even in the case of high frequency shaking. Small sample wells also render thorough mixing difficult due to surface and separation surface conditions. In these cases it can be purposeful to introduce mixing tools in miniaturized form into the individual sample wells of the microtiter plate. In accordance with a form of embodiment not shown in the drawing, a matrix configuration of mixing pins can be provided on the downward facing wall of the cover 9 of the evacuating plate unit 8 or on the underside of a blast nozzle unit provided on said wall, wherein the matrix configuration is arranged at such a level on the evacuating plate unit of the sample processing station in its assembled state that, when the evacuating plate unit is hooked up to a vacuum and sealed off against the device base plate, the individual mixing pins, each assigned to one sample well 7 of the microtiter plate 6, extend into the corresponding sample wells with their bottom tips without touching the bottom of the sample well. The position of the mixing pins within the matrix configuration is selected in such a manner and the drive amplitude of the shaking drive is set in such a manner that during operation and of course, during repose, the mixing pins do not touch the walls of the sample wells. The mixing action comes about in that the sample wells together with their sample contents move in a circular translatory motion around the mixing pins while the mixing pins remain stationary.

In the form of embodiment shown in FIG. 7, a mixing pin plate provided with vacuum holes and grasping openings that can be removed or inserted in place by a robotic manipulator is installed on the microtiter plate 6, said mixing pin plate bearing a matrix configuration of downward extending mixing pins or mixing ladles 65 with respectively one assigned to each sample well 7. The mixing pin plate lies loosely on the upper face of the channel opening plate 53, whereby the vacuum holes and grasping openings of the mixing pin plate 64 and perforations in the mixing ladles 65 make it possible to fill in or empty out the sample wells 7, by means of a pipetting device, without removing the mixing pin plate 64 after separation of the evacuating plate unit 8 from the rest of the device. The mixing pin plate 64 bears indexing means, for example registration holes, and protruding from the microtiter plate or from the channel opening plate 53 are counter indexing means in the form of support knobs 63, such that during the shaking motions of the shaking table plate 3, and by association, of the microtiter plate 6 and of the channel opening plate 53, the mixing pin plate 64 carries out motions relative to the microtiter plate and within a specific range of play due to its inert mass and thereby induces the mixing ladles 65 to carry out movements in the sample wells 7 and thoroughly mix the sample contents, whereby it is ensured that the mixing ladles 65 neither run up against the bottom nor up against the inside walls of the sample wells 7 due to the extent of play range between the mixing pin plate 64 and the channel opening plate 57 or the microtiter plate 6.

A specialist skilled in the art will recognize that the form of embodiment shown in FIG. 7 can also be further expanded in the sense that a blast nozzle unit can be provided over the evacuating plate unit 8 that is tightly placed over the latter and that can again be removed from it. From the blast nozzle plate unit and separate from the other channel connections shown in FIG. 7, a separate lead-through channel configuration is to be arranged through the channel opening plate 57, through the microtiter plate 6 and through the shaking table plate 3 to the flexible line connections leading to ports in the device base plate 1 so that the blast nozzle plate unit can be hooked up to a source for blast gas or inert gas.

Furthermore, FIG. 7 demonstrates the possibility of using magnetic beads, or more specifically, of using coated magnetic beads in the sample wells 7 of the microtiter plate 6 for thoroughly mixing or for separating. To this end, a connecting permanent magnetic holding plate 66 is installed over the shaking table plate 3, and more specifically, over the heat distribution plate 25 provided with the heat transfer knobs 26, said magnetic holding plate being provided with a matrix configuration of perforations through which the heat transfer knobs 26 of the heat distribution plate 25 penetrate. From the connecting permanent magnetic holding plate 66, permanent magnet bases 67 project upward, respectively in the region between a group of four sample bottom ends, said permanent magnet bases bearing on their upper ends permanent magnetic rings 68. The connecting permanent magnetic holding plate 66 in turn is provided with robotic manipulator grasping elements in such a manner that said connecting permanent magnetic holding plate 66 can be set by robotic activation over the shaking table plate 3 or over the heat distribution plate 25 with the heat transfer knobs 26 before the microtiter plate 6 with the channel opening plate 57 is set over the connecting permanent magnetic holding plate and before the evacuating plate unit 8 is set over the latter, given the case that the latter is installed only after the robotically activated placement of the mixing pin plate 64.

In FIG. 7, the groups of magnetic beads on the wall of the sample well, separated by the permanent magnetic ring 68 for the samples of the four adjacent sample wells 7, are designated by reference number 69.

1. A sample processing station, comprising:
a device base plate;
a shaking table plate vertically supported against said device base plate and movable in a horizontal plane;
a shaking drive arranged between and connected to the two said plates for the horizontal movement of the shaking table plate, said movement essentially and exclusively being one of translation, with the means by which to arrest the shaking table plate into a precise resting position;
a microtiter plate holding fixture provided on the shaking table plate; and
a removable microtiter plate inserted in the holding fixture, said plate exhibiting a multitude of sample wells, which can be filled with samples or whose samples can be emptied out by an automatically activated filling or removing device; thus characterized, that over the microtiter plate is a removably arranged evacuating plate unit spanning over the latter, which is formed to be hermetically sealed in such a manner that a vacuum is permitted to be generated in all of the sample wells of the microtiter plate and which is controllably connectable to a vacuum source or to a directed airflow source via ports in the device base plate.

2. The sample processing station in accordance with claim 1, wherein heat can be conducted to the bottom ends of the sample wells originating from an electrical surface heating device provided on the shaking table plate, said electrical surface heating device being connected via flexible lines to a power supply terminal in the device base plate.

3. The sample processing station in accordance with claim 2, wherein the surface heating device on the shaking table plate exhibits a metal heat distribution plate, arranged over a surface heating element, from which heat transfer knobs formed as one piece protrude, said knobs each respectively being assigned to a corresponding sample well.

4. The sample processing station in accordance with claim 3, wherein located between the heat transfer knobs and the sample well bottom ends is a continuous, pliable heat transfer layer, more specifically in the form of a heat conducting foamed plastic mat.

5. The sample processing station in accordance with claim 4, wherein the space over the heat distribution plate and under the heat transfer layer around the heat transfer knobs along the lateral edges of the shaking table plate is hermetically sealed and via a lead-through channel configuration penetrating through the heat distribution plate, the surface heating element and the shaking table plate as well as via flexible line segments in the direction to the device base plate, is controllably connected to a cooling medium circuit.

6. The sample processing station in accordance with claim 1, wherein the microtiter plate exhibits a through-going sample container connecting plate at the level of the base container bottom ends and/or at the level of the sample container flow openings, that the space around the individual sample containers above or below the sample container connecting plate as well as along the lateral edges of the microtiter plate is hermetically sealed off and is controllably connectable to a heating medium circuit and/or to a cooling medium circuit by means of a lead-through channel configuration extending up to the underside of the shaking table plate as well as via flexible lines in the direction to the device base plate.

7. The sample processing station in accordance with claim 1, wherein that over the sample well connecting plate or over a sample container connecting plate connecting the sample containers at the level of their flow openings is located a channel opening plate securely connected to the microtiter plate, from which channel opening plate channel connections, specifically provided with lower slosh baffle rings, extend as one piece to the individual sample container openings and that the space over the sample container connecting plate and below the channel opening plate around the individual channel connections along the lateral edges of the microtiter plate is hermetically sealed off and is controllably connectable to a cooling medium circuit by means of a lead-through channel configuration extending through the microtiter plate and finally up to beneath the shaking table plate and via flexible line segments in the direction to the device base plate.

8. The sample processing station in accordance with claim 1, wherein over the evacuating plate unit is provided a blast nozzle plate unit with a number of blast nozzles corresponding to the number of sample wells of the microtiter plate, of which the blast channels, each respectively oriented toward the corresponding sample well opening, penetrate through a wall of the evacuating plate unit turned toward the microtiter plate and are all connected to a blast medium supply chamber or to a blast medium supply channel system, said blast medium supply chamber or channel system being connected to a blast gas source.

9. The sample processing station in accordance with claim 1, wherein the evacuating plate unit exhibits lateral walls whose lower edge releasably provides a hermetic seal against the device base plate that is formed to be gas tight for the surroundings.

10. The sample processing station in accordance with claim 8, wherein the drive amplitude of the shaking drive is selected in such a manner that the flowing gas blasts, exhibiting unchanged positioning opposite the device base plate, discharged from the individual nozzle channels always exclusively hit on the flow opening of the corresponding sample well.

11. The sample processing station in accordance with claim 1, wherein the evacuating plate unit exhibits lateral walls whose lower edge around the lateral edge of the microtiter plate provides a releasably hermetic seal against the shaking table plate that is formed to be gas tight for the surroundings and that the inner space in the evacuating plate unit is controllably connectable to the vacuum source or to the directed airflow source by means of a lead-through channel configuration penetrating the shaking table plate and via flexible line segments to the device base plate.

12. The sample processing station in accordance with claim 1, wherein the evacuating plate unit exhibits lateral walls whose lower edge releasably seals off against a sealing edge of the microtiter plate surrounding all of the sample container flow openings, and that the inner space in the evacuating plate unit is controllably connectable to the vacuum source or to the directed airflow source by means of a lead-through channel configuration penetrating the microtiter plate and the shaking table plate and via flexible line segments to the device base plate.

13. The sample processing station in accordance with claim 11 wherein on the upper face of the microtiter plate or on the upper face of a channel opening plate set thereupon, support knobs protrude which are located between the sample container flow openings and against which the downward extending wall surface of the cover wall of the evacuating plate unit is supported during action of the vacuum upon the inner space thereof.

14. The sample processing station in accordance with claim 9 wherein on the underside of the evacuating plate unit is provided a matrix configuration comprised of mixing pins that are securely connected or securely connectable to said evacuating plate unit underside, whereby the matrix configuration is set or is adjustable at such a level on the evacuating plate unit that, when the evacuating plate unit is under vacuum and is hermetically sealed off against the device base, the individual mixing pins each respectively assigned to one sample well of the microtiter plate extend with their bottom tips into the corresponding sample wells without touching the bottom thereof, wherein the position of the mixing pins in the matrix configuration and the drive amplitude of the shaking drive are set in such a manner that, during operation and during repose, the mixing pins do not come in contact with the inside walls of the sample wells.

15. The sample processing station in accordance with claim 11 wherein that the microtiter plate, which exhibits indexing means, is provided with an insertable or removable mixing pin plate with vacuum holes and grasping openings, which bears a matrix configuration of downward extending mixing pins or mixing ladles with respectively one assigned to each sample well, said mixing pins or mixing ladles extending with their bottom tips into the corresponding sample wells without touching the bottom thereof, whereby the mixing pin plate together with the indexing means of the microtiter plate exhibits counter indexing means interacting with horizontal clearance of motion and the position of the mixing pins in the matrix configuration and the horizontal clearance of motion are selected in such a manner that during operation and during repose of the shaking drive, the mixing pins do not come in contact with the inside walls of the sample wells, and whereby the inert mass of the mixing pin plate and its frictional relation to the microtiter plate are adjusted in such a manner that during operation of the shaking drive, the mixing pin plate carries out relative movements within the mentioned horizontal clearance of motion opposite the microtiter plate.

16. The sample processing station in accordance with claim 15, wherein the mixing pin plate exhibits a matrix configuration comprised of perforations oriented toward the sample container openings of the microtiter plate from whose boundaries the mixing pins or the mixing blades each respectively project downward, and which serve to fill or empty the sample containers without removal of the mixing pin plate from the microtiter plate.

17. The sample processing station in accordance with claim 1, wherein the microtiter plate exhibits a sample container connecting plate at the level of the sample container bottom ends and/or at the level of the sample container flow openings, thus characterized in that in the region between each respective group of four sample container bottom ends or of four sample container flow openings, permanent magnet base through-going openings are provided and that a permanent magnet base matrix configuration is arranged either under the microtiter plate or over the microtiter plate whose permanent magnet bases are either insertable from below in the upward direction or from above in the downward direction into the permanent magnet through-going openings into the spaces between the sample container groups of four.

18. The sample processing station in accordance with claim 17, wherein the permanent magnet bases project outward from a permanent magnet base connecting plate which is arranged beneath or above the microtiter plate to be removable from the latter.

19. The sample processing station in accordance with claim 1, wherein the device base plate and to the shaking table plate supported thereupon, the microtiter plate, a permanent magnet base plate, which is possibly arranged either under or above said microtiter plate, a mixing pin plate, which is possibly arranged over the microtiter plate, the evacuating plate unit spanning over the microtiter plate exhibit robotic manipulator grasping elements for interaction with the manipulator of a single robot and based on the desired selection, are stackable or separable from one another.
